(19) United States
(12) Patent Application Publication
(10) Pub. No.: US 2021/0148586 A1
(43) Pub. Date: May 20, 2021

(54) Radiant Panel with Fresh Air

(71) Applicant: Hall Labs LLC, Provo, UT (US)

(72) Inventors: David R. Hall, Provo, UT (US); Arjun Krishna, Orem, UT (US); Benjamin Jensen, Provo, UT (US); Jeremy Johnson, Salem, UT (US); Justen Hansen, Stansbury Park, UT (US); Caleb Marsh, Provo, UT (US); Brett Johnson, Provo, UT (US)

(73) Assignee: Hall Labs LLC, Provo, UT (US)

(21) Appl. No.: 16/687,682

(22) Filed: Nov. 18, 2019

(51) Int. Cl. F24F 5/00; F24D 3/14; F24D 19/00

(52) U.S. Cl. CPC F24F 5/0089; F24D 19/00; F24D 3/14

(57) ABSTRACT

The invention is, in one aspect, a system for heating or cooling a room, including a radiant panel with fluid conduit, which, radiates energy to a room. A heat exchange device exchanges energy between the fluid in the radiant panel and an exchange medium. A vent allows fresh air to enter a room, moved by a fan. The fan propels the air through a chamber for heating or cooling the air, wherein the chamber at least partially comprises the radiant panel.

### CROSS-REFERENCE TO RELATED APPLICATION

The present application is a Continuation-In-Part application of U.S. application Ser. No. 16/424,465, filed May 28, 2019 and entitled “System for Heating and Cooling a Room Spaced from a Wall.” The entire disclosure of the prior application is incorporated herein by reference.

### TECHNICAL FIELD

The present invention relates to radiant heating and cooling devices.

### BACKGROUND

Various solutions exist for heating and cooling spaces. Heating can be provided to a complete building, such as a residence, by a furnace that heats air, e.g. by combustion of a gas, which heated air is blown through vents into the building. Also, a boiler can heat water, oil, or other fluids, which circulate through pipes or radiators to heat rooms with radiant heat. Alternatively, electrical heaters can convert electricity to heat. Similarly, cooling can be provided with forced central air, chilled fluids that are pumped through pipes or radiators, and local electrical air conditioners.

Some radiant heating systems are standalone units. Others are installed in floors. Sometimes, they are also installed in walls and ceilings. Some more recent radiant heating systems use PEX (cross-linked polyethylene) pipes or other types of pipes that are placed throughout the floor, wall, or ceiling, and water circulates through the pipes to heat the surrounding space. However, when the pipes in which the water circulates cover a small portion of the surface area where they are installed, such radiant heating systems may result in slow or uneven heating, especially when objects such as couches, bookshelves, pictures, or clocks are placed in front of or over the top of the system. Furthermore, such systems can be difficult to construct, install, or repair. Additionally, radiant heating systems lack the ability to provide fresh air to a building.

### SUMMARY

In a first aspect, a system for heating or cooling a room is provided. A radiant panel with fluid conduit radiates energy to a room. A heat exchange device exchanges energy between the fluid in the radiant panel and an exchange medium. A vent allows fresh air to enter a room, moved by a fan. The fan propels the air through a chamber for heating or cooling the air, wherein the chamber at least partially comprises the radiant panel.

In a second aspect, the invention provides a method of heating or cooling air, including: heating and cooling a refrigerant within a heat pump; pumping a fluid from the heat pump, through a radiant panel, and back to the heat pump; receiving outdoor air through a vent; warming or cooling the outdoor air a first time by exchanging energy between the refrigerant and the outdoor air while simultaneously exchanging energy between the refrigerant and the fluid; and warming or cooling the outdoor air a second time by passing the outdoor air over the radiant panel.

In a third aspect, the invention is a system for passing heat through a single exterior wall of a building including a pump for pumping a fluid through a closed-loop system which includes a radiant panel and a heat exchange device. The fluid flows from the heat exchange device, makes a first pass through an interior sheet of the exterior wall within the first line, flows through the radiant panel, makes a second pass through the interior sheet of the exterior wall within the second line, and back to the heat exchange device. The invention also includes an enclosure for the heat exchange device which is less than 14.75 inches wide and less than 5 inches deep. The enclosure also has a vent to allow air from outside to enter the enclosure and a fan for moving air through the vent.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an exploded perspective view of a system for heating or cooling a room according to one embodiment of the invention including a transmission tube.

FIG. 2 is a perspective view of one embodiment of the invention including spacing elements.

FIG. 3 is an elevation view of embodiment of the invention including a heat pump.

FIG. 4 is a rear exploded perspective view of a system for heating or cooling a room.

FIGS. 5a-5c are perspective views of embodiments of the invention using various layers of channels.

FIG. 6 is a perspective view of one embodiment of the invention including a vacuum layer.

FIG. 7 is a front view of one embodiment of the invention wherein the channels are grouped into zones with the use of plugs.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “contiguous,” as in “contiguous channels,” is generally meant to refer to the channels being separated by a common wall, although the key feature is that the channels are adjacent to each other.

As used herein, “heated,” as in “heated water,” is meant to refer to water that is above the ambient temperature of the room.

Likewise, as used herein, “cold” or “cooled,” as in “cold water” or “cooled water,” is meant to refer to water that is below the ambient temperature of the room.

As used herein, “radiant area” is defined as the total cross-sectional area of the heated or cooled fluid in the plane parallel to the surface of the wall. For example, if an array of circular pipes containing heated fluid was in a wall, the radiant area would be total length of pipe in the wall, times its diameter. Radiant area does not include transport piping or area of fluid outside the room being heated or cooled.

As used herein, “exchange medium” means matter which is an energy sink or an energy source depending on the needs of the system. For example, an exchange medium could comprise earth, air, water, refrigerant, etc. “Exchange medium” only refers to mediums of forced exchange rather than downstream uncontrolled energy exchange.

As used herein, a “closed-loop system” means a system of piping, channels, or other fluid containing tubular vessels which primarily reuses the same fluid rather than introducing new fluid during use of the system.

As used herein, the term “panel” is to be given a relatively broad meaning, referring to a component that has a depth smaller than the height and width. Preferably, the panels in this invention are flat and rectangular. Nevertheless, the panels may also be curved, bent, and have shapes other than rectangles. Panel may refer to one portion of a prebuilt wall, or it may refer to one portion of a wall that is built from scratch in place, or it may refer to a free-standing component.

As used herein, “thermal communication” refers to the exchange of energy between components, whether it be by conduction, convection, or radiation.

As used herein, “conduit” refers to a pathway for fluid to travel, whether it is traditional piping or the channels of twinwall or corrugated plastic.

As used herein, “heat exchange device” refers to a mechanism that exchanges energy from one medium to another, for example, a heat pump.

As used herein, “heat exchanger” refers to a mechanism that directly exchanges energy between one medium and another, for example, the condenser or the evaporator of an air conditioning unit.

As used herein, “fresh air” refers to air from outside or a different room than the space being heated or cooled.

Radiant heating, as opposed to convective heating, is popular due to its quiet nature and the fact that it does not spread allergens. It can also be more efficient than convective heating because it does not require heating up the air of the building before a user can feel the warmth. Similarly, radiant cooling, although not as popular as radiant heating, is a quiet, efficient, and nondisruptive way to cool a building. Radiant panels can be configured to run in a cooling mode when cooler temperatures are desired and a heating mode when warmer temperatures are desired.

Radiation is the transferring of electromagnetic energy in the form of infrared rays from one surface to the other surfaces around it. The amount of energy transferred depends on the both the temperature and area of the surface. A higher temperature and a larger surface area will increase heat transfer. Therefore, it is beneficial to increase the temperature and the surface area of a radiant heater. Or conversely, increasing the surface area can allow a radiant heater to operate at cooler temperatures, which may be useful when a source of heat is not hot enough to operate with a smaller surface area. It also can be safer. Similarly, a larger area for a radiative cooler can absorb more energy from the room as the objects in the room radiate to it, helping the room to cool down more quickly.

However, because radiant panels heat and cool a room without forced air, a separate system must be installed to introduce enough fresh air into the building to meet building codes. This adds extra cost in terms of equipment, building materials, and labor. It also takes up more space in the home in terms of equipment and ductwork. In one embodiment of the present invention, a heating or cooling system includes a radiant panel and a vent for fresh air. In another embodiment of the invention, the system not only heats or cools a fluid running through the radiant panel, but also heats or cools the fresh air. The fluid and the air may each have their own respective heaters or coolers, however, in the preferred embodiment of the invention, a single heater or cooler is used to heat or cool both the fluid and the air.

Further, radiant panels are difficult to install into a building or home after it is built. This is because the fluid running through the panel is usually piped to a heating or cooling source distant to the panel. Many radiant panels receive heated or cooled water from a boiler in a basement, a geothermal heat exchanger outside, or a heat pump at a distant location from the panel. Each of these setups can be extremely difficult to install after the building is complete.

Additionally, because the piping for radiant heating or cooling typically runs through a whole building, it can be difficult to give special attention to problem spots, such as hot sunny areas or cold drafty areas. Many times, a single thermostat controls the system for an entire house or for an entire section of a building. Small changes in air flow or sunlight can cause neighboring rooms to have vastly different temperatures. What is needed is a way to heat or cool a building with radiant panels that allows each room to be controlled individually.

Finally, heating and cooling systems typically suffers from energy losses from the piping and ductwork between source of energy and the destination. When the mechanism heating or cooling the water or air is located far away from the destination, the piping and ductwork absorb or lose heat to the air around the piping or ductwork during transfer. As length increases, the system gets more inefficient. Further, as piping and ductwork length increases, the more friction the fluid and air have to overcome, which requires more energy, making the system even more inefficient. Therefore, energy can be saved by making the piping and ductwork as short as possible.

The invention includes a heater or cooler coupled to a radiant panel which allows energy to be exchanged between a room and the outside air. The system exchanges energy with both a fluid running through the radiant panel and also a flow of air entering the building. This allows a user to add radiant panels with much less time, material, and cost of adding radiant panels the traditional way. It also allows problem rooms with hot spots or cold spots to be fixed without overheating or overcooling the entire building. Further, it minimizes the distance a fluid and air travel from the time they are heated or cooled to the time they reach their destination. This minimizes both heat loss and friction in the piping and ductwork.

In one embodiment of the invention, a radiant panel is disposed on the inside of an exterior wall of a building. A heat pump is placed within the wall behind the radiant panel. A vent may be in the exterior wall behind or near the heat pump so air can be exchanged with the heat pump and outside the building.

A heat pump located in the wall is a way for the radiant panel to be in close proximity to a source of heated or cooled fluid. For reasons previously discussed, the closer the source of heated or cooled water is to the radiant panel, the better. In one embodiment of the invention, the tubing that connects the radiant panel and the heat pump is less than ten feet. In another embodiment of the invention, the length is less than five feet. In yet another embodiment of the invention, the length is less than two feet. In yet another embodiment of the invention, the radiant panel connects directly to the heat pump.

The radiant panel itself may come in many configurations. It can be many different sizes and shapes and be made from different materials. Some configurations, such as a traditional pex or pvc water pipe in serpentine fashion provide less radiant area, but may be suitable for some applications. Other configurations, as discussed below provide much more radiant area. Further, the panel may contain additional layers such as insulation, foil, or a sound barrier.

In one embodiment of the present invention, the area of a radiant heater or cooler is maximized by running heated or cooled fluid through a panel made primarily of channels for fluid. One example is an extruded plastic panel of rectangle channels commonly called “corrugated plastic” or “twinwall.” The channels may be contiguous such that each channel shares a wall, or partition, with an adjacent channel. This way, most or all of the area of the panel is radiant area. This provides much more radiant area than a panel or wall with traditional pipes running through it. It also minimizes leaking and maintenance because fluid from a leaky channel may go into the adjacent channel. In some embodiments, the radiant area is preferably greater than 20% of the panel. Even more preferably, the radiant area is greater than 50% of the panel. Even more preferably, the radiant area is more than 90% of the panel. The greater the radiant area is, the smaller the heat differential between the heating or cooling fluid and the room needs to be.

Although the radiant area of the panel is maximized by using corrugated plastic, radiant panels may be made by other means as well. For example, they may be made with a pipe, such as PVC, PEX, or metal winding back and forth across the panel in a serpentine configuration. These typically are much thicker and heavier than corrugated plastic, in addition to giving or receiving less radiative energy.

The fluid used in the system to transfer energy into or out of the room could be any fluid that is not harmful to the system, including gases or liquids. Liquids, such as water, have many ideal characteristics, such as high emissivity, high specific heat, and low cost. However, water tends to allow growth of organisms and has the potential of freezing. Glycols, such as ethylene glycol or propylene glycol, are commonly added to water to lower the freezing point and prevent growth of organisms. However, glycol reduces the specific heat of the mixture, so more volume is required through the system than with water alone. There are many glycols which share similar physical properties and are suitable for use in the invention, but the preferred embodiment typically uses a mixture of water and propylene glycol because it is non-toxic and safer if there is a leak or spill. Preferably, the fluid is a water mixture with 20% to 45% glycol. Even more preferably, the fluid is a water mixture with 25% to 40% glycol. Even more preferably, the fluid is a water mixture with 30% to 32% glycol. In other embodiments, the fluid contains oil, such as diathermic oil, which has the additional benefit of remaining a liquid at higher temperatures than water.

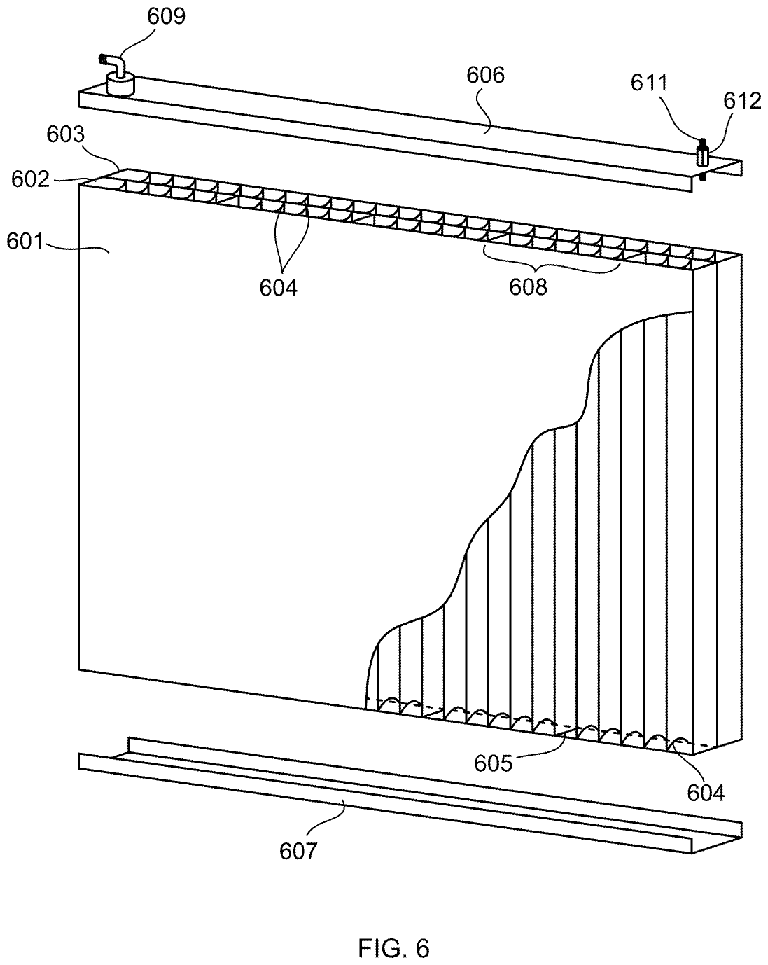

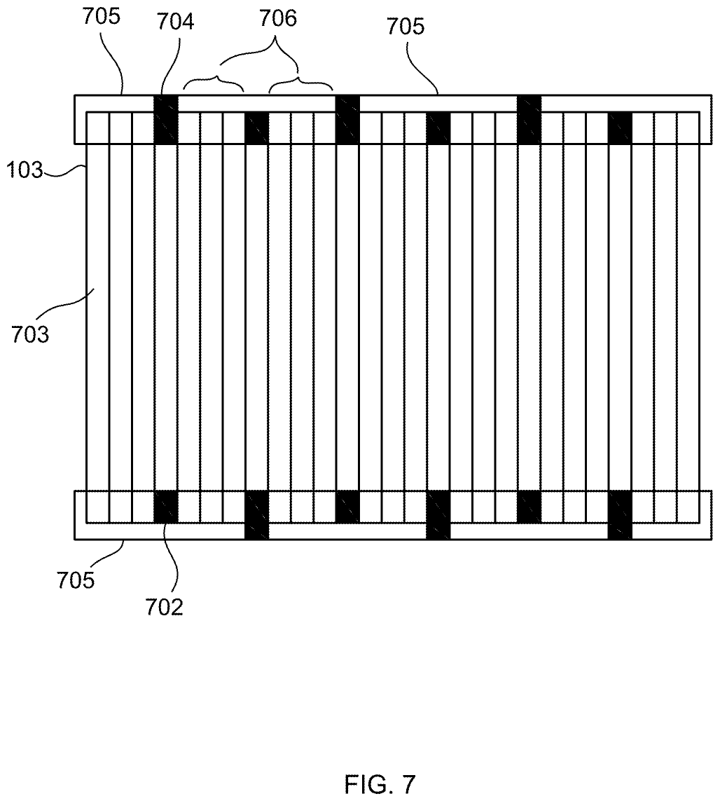

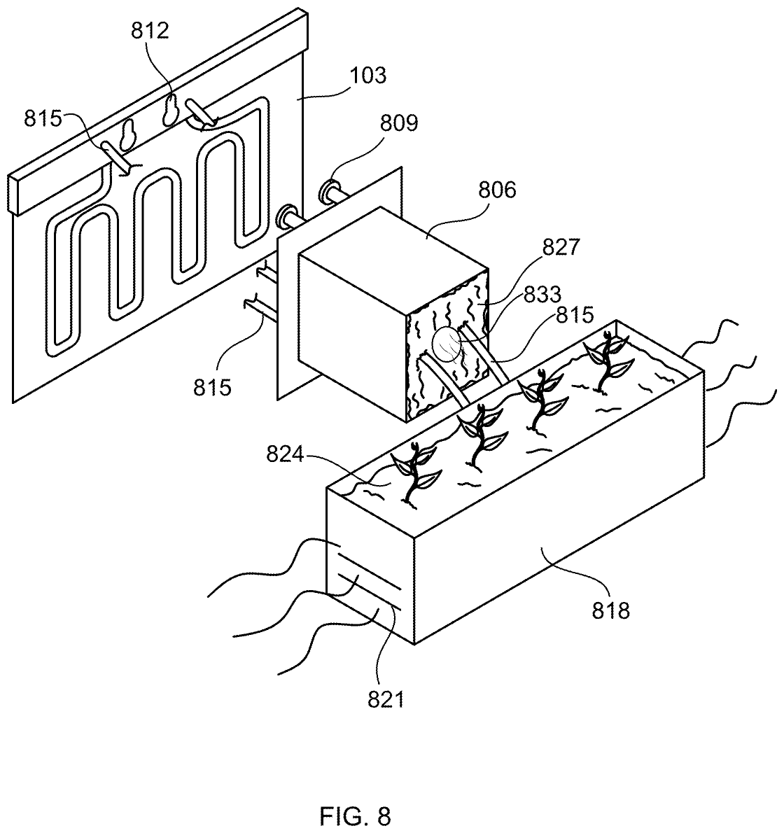

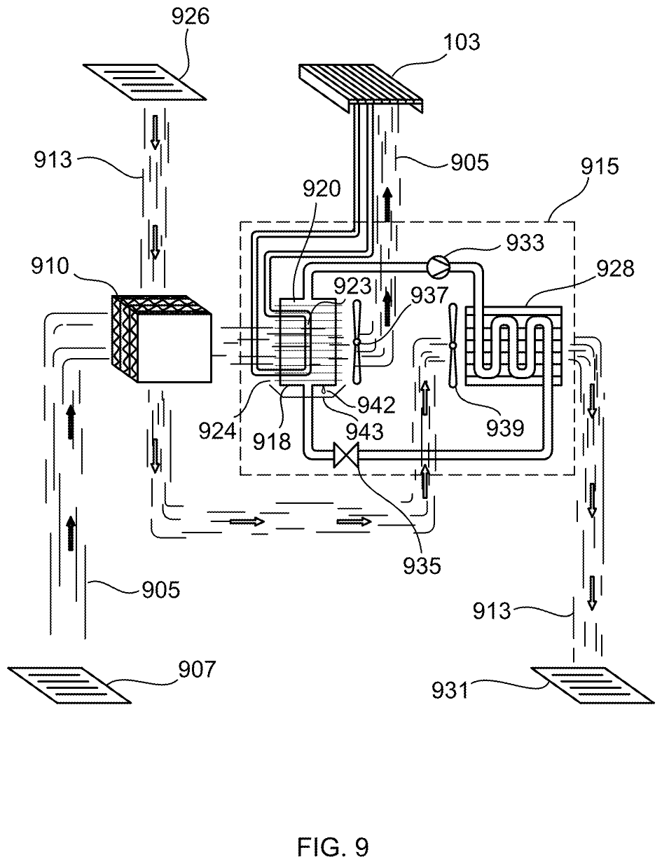

In a preferred embodiment, the friction in a radiant panel made from corrugated plastic is reduced by dividing it into zones rather than alternating the fluid up and down each adjacent channel, wherein a zone is a multiple of adjacent channels where the fluid is travelling in the same direction. In one embodiment, zones are created by putting notches in the end of the partitions dividing the channels. This way, fluid is able to flow freely across the notches and then down the channels to the other side where it is directed to an adjacent zone. See FIG. 6 for an example. Another way is with an endcap placed over an open end of a panel that puts some channels in communication with each other while blocking off others. In that configuration, there may be an opposing and corresponding endcap configured to provide the same zones as depicted in FIG. 7.

The invention also provides flexible installation options, including covering options. In one embodiment, the panel includes a finishable surface, such as the fibrous surface of drywall. In other embodiments, the panel includes a decorative surface, such as a wallpaper, paint, or a canvas with a printed image. These options will help to make the panel's appearance unnoticeable or stand out, as desired. The decorative covering preferably also has a low thermal conductivity but a high emissivity, such as a velvet wallpaper, to make the wall cooler to the touch while still warming the room through radiation.

In other embodiments, the panel has a layer of insulation, typically on the back side, either to reduce heat transfer toward the wall or to reduce noise from the outside, or both. Insulation could be traditional fiberglass or foamboard, or it could comprise a second channel layer configured to insulate. In one embodiment, one or more additional channel layers, preferably made of twinwall, may be used and is filled with sound damping material such as soil or barite. In other embodiments, additional channel layers may be used with a layer of air to discourage sound vibrations and heat transfer. In yet another embodiment, the layer of insulation is set at a distance behind the radiant panel to create a chamber for air to flow through. This is beneficial when the panel is used to heat or cool an air stream that is directed into the room while preventing energy from flowing through the wall on which the panel is hung.

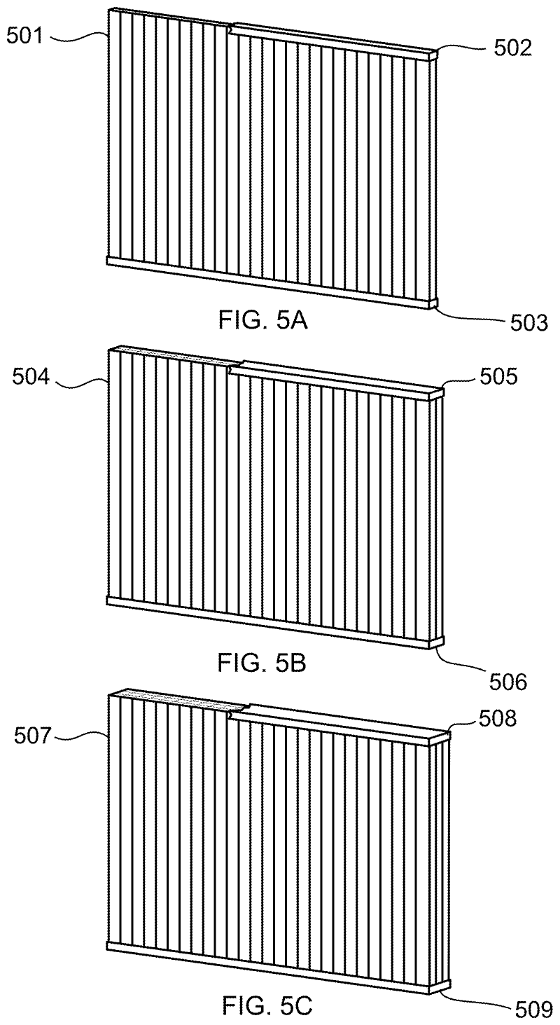

One embodiment of the invention utilizes multiple channel layers configured to aid insulation, noise reduction, or reduce condensation by creating a vacuum in one of the layers. This is possible by using multiple sheets of extruded material which are placed adjacent to each other or a single panel of extruded material which has multiple channel layers within it. Channels of air make great insulators, but channels with a vacuum are better because there is no convection or conduction through an empty space. One embodiment of the invention has a single panel with three channel layers, as depicted in FIG. 5. Cooled or heated fluid may run through the layer closest to the room to deliver heat to the room, and the middle or rear layer would have a vacuum. The third layer may also have a vacuum, or it could be filled with air or an insulator, such as barite, or it could be a second fluid-containing layer. In the preferred embodiment of this configuration, the vacuum layer is on the front and the fluid-containing layer is in the middle or back. This could drive radiation as the main heat transfer mechanism. In some cases, this may help with condensation on the front of the wall, especially during cooling. This is because the temperature of the front of the panel will be somewhere between the temperatures of the fluid layer and the room, especially if its temperature is closer to room temperature.

The invention can be versatilely installed onto the wall of a building. It can be configured to be retrofit into established buildings, or it can be installed into new buildings. In one embodiment, it can be supported by the wall with hanging hardware. In another, it can replace drywall and be supported by a support structure, such as wooden studs. In one embodiment of the invention, a single panel is installed in a room. In other embodiments, more than one panel can be connected with fluid communication between the panels, which will increase the radiant area.

Another embodiment of the invention uses a reflective layer disposed within the panel to help direct heat transfer in a particular direction. Materials with very low emissivity, such as aluminum, brass, chromium, or silver, among others, may be placed on the back side of the panel in order to reduce radiation toward the exterior wall. In the preferred embodiment, a reflective layer will have an emissivity lower than 0.1 and be economically sourced, such as aluminum foil with an emissivity of approximately 0.04.

The heat exchange device may also take various forms. It may only provide either heated or cooled fluid, or it may have a reversing valve and be able to provide heated and cooled fluid, depending on the mode. It may also take different shapes and sizes. Further, it may be configured to heat or cool only one type of fluid, such as a liquid like water and/or glycol, or it may be able to heat or cool air in addition to a liquid. The heat exchange device may include a vent to the outside air either directly behind it or at another location. The vent may be covered or disguised so it is aesthetic or not noticeable from an outside viewer. Additionally, the heat exchange device may be outside the building and in fluid communication with the panel through an exterior wall.

The heat exchange device may comprise an enclosure that enables it to fit substantially within the wall of a building. One example embodiment includes an enclosure that is 14-14.5″ wide so it may be easily supported by a stud on each side. In other embodiments, the enclosure is smaller and uses adjustable brackets which take up the remaining space between two studs. In yet additional embodiments, the enclosure is supported by cross bars which mount between two studs, allowing the enclosure to be smaller. In yet additional embodiments, the enclosure is supported by an interior and/or exterior sheet of exterior wall, such as drywall or a sheet of wood. In a preferred embodiment, the wall is an exterior wall, so the energy from the room may be exchanged with air exterior to the building, however, the invention may be used strategically in an inner wall if there is enough of a heat sink available to provide or absorb heat to or from the room being heated or cooled.

In one embodiment of the invention, the enclosure fits substantially within the wall, meaning less than half of the enclosure protrudes from the front of the wall. In another embodiment, the enclosure is completely behind the front surface of the wall. In yet another embodiment, the enclosure fits behind the front surface of the wall except for a brim designed to cover the cut portion of the wall and/or a front cover plate.

The enclosure may also contain other characteristics which make it suitable to be installed within a wall. For example, it may contain vents in one or more of its walls to allow air to enter and exit the enclosure. In the preferred embodiment, one or more vents are in the back side of the enclosure so air can be vented directly through a hole in the building wall and into the enclosure without the need for additional air ducts. This also makes it easier to cut the hole in the external layer of the external wall for venting because it overlaps with the hole in the internal layer of the external wall. The enclosure may also contain one or more holes in the front cover to allow pipes for the fluid from the radiant panel to enter the enclosure.

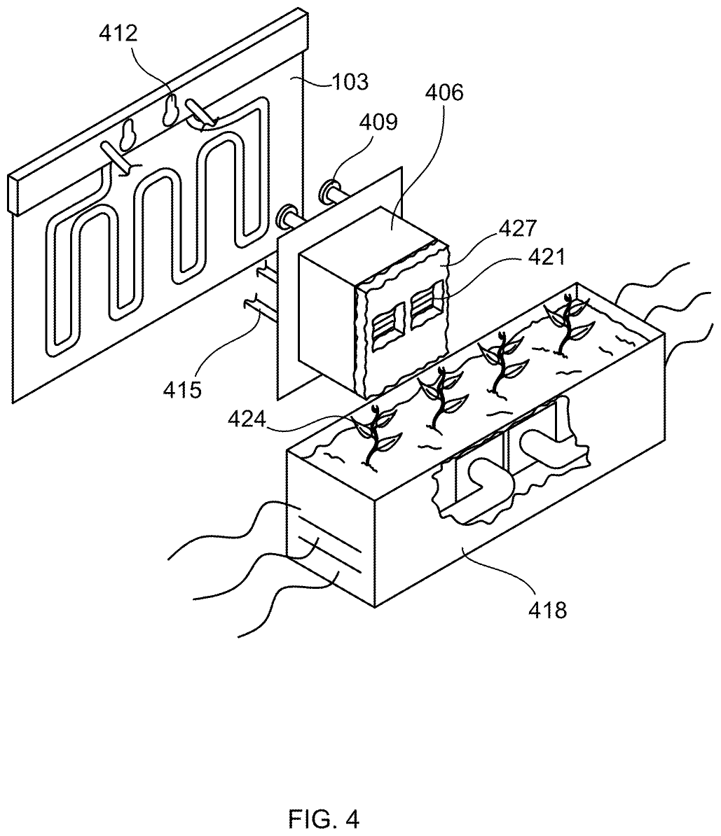

The enclosure may also be used as a means to mount the radiant panel. It may comprise hardware, such as hooks protruding from the front of the enclosure into the room, which mate with receiving support structures on the panel, as shown in FIG. 4.

In one embodiment of the invention, the heat exchange device is a heat pump. The heat exchange may take place at a condenser or an evaporator within the heat pump. In one embodiment, the heat pump contains a reversing valve, which allows it to provide heat to the radiant panel while in a heating mode and to receive heat from the radiant panel while in a cooling mode.

The heat exchange device may be coupled with a blower, or fan, to provide air to the room being heated or cooled. The blower may blow air over an evaporator or a condenser to heat or cool the air prior to flowing into the room. In another embodiment, the air is blown directly along the back side of the radiant panel to heat or cool the air before dispersing into the rest of the room. One variant of this embodiment is that the air received by the blower is recycled from the room, directed through the heat exchange device, and back to the room. Another variant is that fresh air is received from outside. Alternatively, the air may be from another room in the building.

Alternatively, another embodiment of the invention includes a recycled air stream that is heated or cooled by the radiant panel without entering the heat exchange device. A fan may be disposed behind or near a radiant panel that pulls air from the room so that it may flow through a chamber comprised of one side of the radiant panel and back into the room. This may help keep air-noise levels to a minimum because the cross-sectional area of an air-port to a heating or cooling chamber comprised of the radiant panel may be larger than the cross-sectional area of an air-port on the heat exchange device. Preferably, a tangential fan quietly blows air through the chamber, although other types of fans may be suitable. Further, filters may be added to the chamber to clean the air as it passes through.

In another embodiment of the invention, the heat exchange device is disposed exterior to the room being heated or cooled rather than inside the wall. A hole may need to be cut in an exterior wall through which to run fluid lines and air. To aide with installation, a transmission tube may be used, which creates an easy port through which to run fluid lines and an air duct, and which also may have other uses, such as a mounting the radiant panel and/or the heat exchange device.

The transmission tube may take any of a number of different shapes, sizes, and configurations. In one embodiment of the invention, the transmission tube is a circular duct that goes straight through the wall. In many instances a hole may be drilled from the inside of the wall, through the insulation, wall panel, and exterior surface, such as brick or siding, in one motion. This provides a quick installation option. It also allows for a single straight pipe or duct to be used as the transmission tube. In other embodiments, the hole through the interior wall and the hole through the exterior are drilled separately. This is especially necessary where the holes cannot be concentric, such as when there is a feature on the exterior of the house forbidding the heat pump to be directly behind the radiant panel. In some embodiments of the invention, flexible tubing may be used as the transmission tube.

The transmission tube provides a pathway for the fluid to travel between the radiant panel and a heat pump, but it also may serve other functions. In one embodiment of the invention, the heat pump receives electricity from a source external to the house. In another, a power cord passes through the transmission tube to the interior of the house. There, it may be plugged in or hard wired inside the wall. In yet another embodiment of the invention, the transmission tube allows the passage of air. It may be a duct that itself is capable of passing air, such as one that is air-tight and not conducive to corrosion. Or it may contain a separate air passage tube within it.

In one embodiment of the invention, the transmission tube is spool-shaped, wherein the tube includes two flanges and a pipe between them. This provides an efficient way to install the transmission tube in addition to providing cover plates to seal each side of the hole. One variant of this embodiment includes two threaded flanges that screw onto a pipe. Another variant includes two flanged pipes, each of which have mating threads so the flanges can screw together within the wall to make a spool shaped tube. As the pipes screw together, the flanges abut the inside wall and the outside wall.

The flanges of a spool shaped transmission tube may also serve as mounting plates for other components. For example, in one embodiment of the invention, the external flange includes pegs on which a heat pump could be hung. In another embodiment, the internal flange includes clips to fasten a cover. In another embodiment, the internal flange includes a mounting hook or fastener for the radiant panel. In yet another embodiment, the external flange is a part of the enclosure for the heat pump.

To make the invention even more efficient, energy from the air inside the air that is exiting the building may be transferred to new air entering the room through an energy recovery device. An energy recovery device, as depicted in FIG. 9 passes two fluids of different temperatures near each other so they may exchange energy. For more about an energy recovery device, see U.S. Pat. No. 4,377,400A, the disclosure of which is hereby incorporated in its entirety into this application.

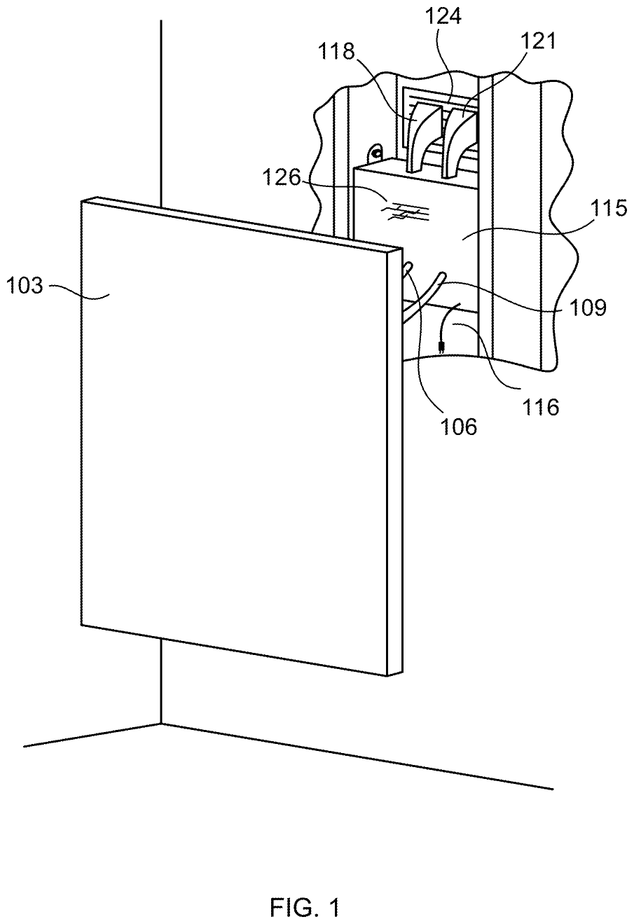

Now referring to FIG. 1, which shows an exploded view of one embodiment of the invention. A radiant panel 103 has an inlet pipe 106 and an outlet pipe 109. The pipes connect to a heat exchange device 115. In this configuration, the heat exchange device receives power from an electrical plug 116, which is plugged in inside the building. The heat exchange device 115 includes an air inlet 118 and an air outlet 121, which put the heat exchange device in communication with a vent 124, which vents to the exterior of the building. An internal vent 126 allows air, which has been heated or cooled by the heat exchange device, to enter the room.

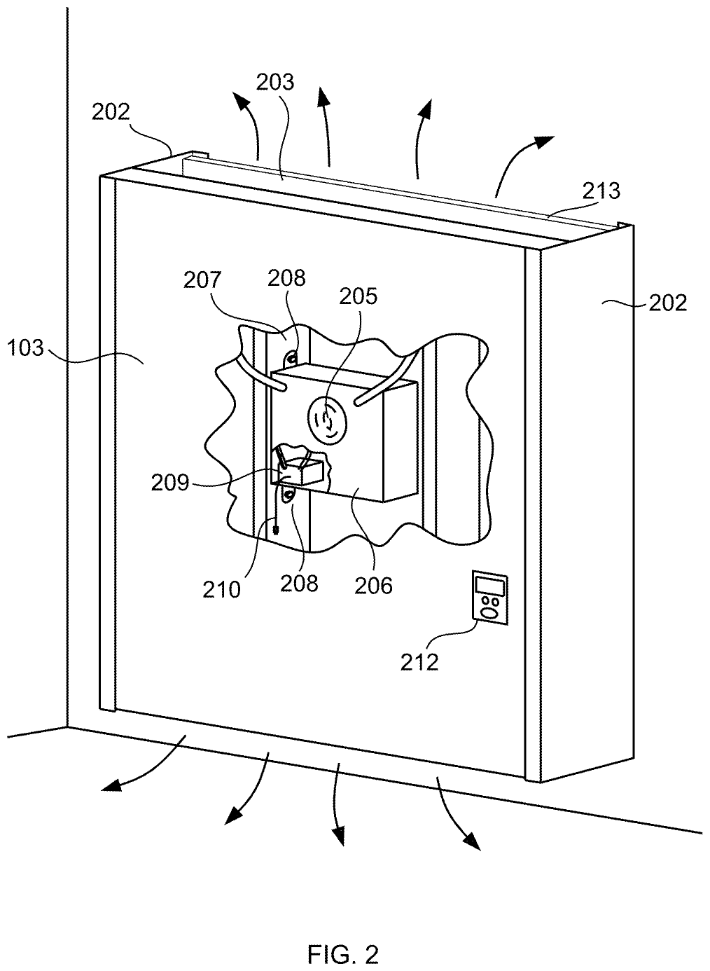

Now referring to FIG. 2, a heating or cooling system is depicted with a gap between a radiant panel and a wall to allow airflow. A radiant panel 103 is attached to a wall with two mounting brackets 202. The mounting brackets 202 are also spacers which create an air-channel 203 between the wall and the panel 103. A blower 205 may help air flow and energy transfer to or from the room as well as help remove condensation from the panel. As depicted, the blower 205 brings air in from outside the building. In another embodiment of the invention, air may also be recycled from inside the room, entering the air-channel from one side, passing behind the radiant panel, and exiting from another side. In one embodiment of the invention, the mounting brackets set the panel from the wall at small distance, such as 1/16″ in order to maximize heat transfer with the air. In other embodiments, the distance is greater, such as 3″-6″, depending on air flow, in order to make the air flow more quietly. An enclosure for an in-wall heat exchange device 206 lies behind the panel and within the wall and is attached to a stud 207 with two mounting brackets 208. A power supply 209 receives electricity from an electrical cord 210, and supplies electricity to the components of the heat exchange device, the blower 205, and other components, such as a pump for the fluid in the radiant panel (not shown), through electrical wires 211. The power supply may also supply electricity to a control panel 212, which may control the system. A layer of insulation 213 prevents energy from seeping through the wall.

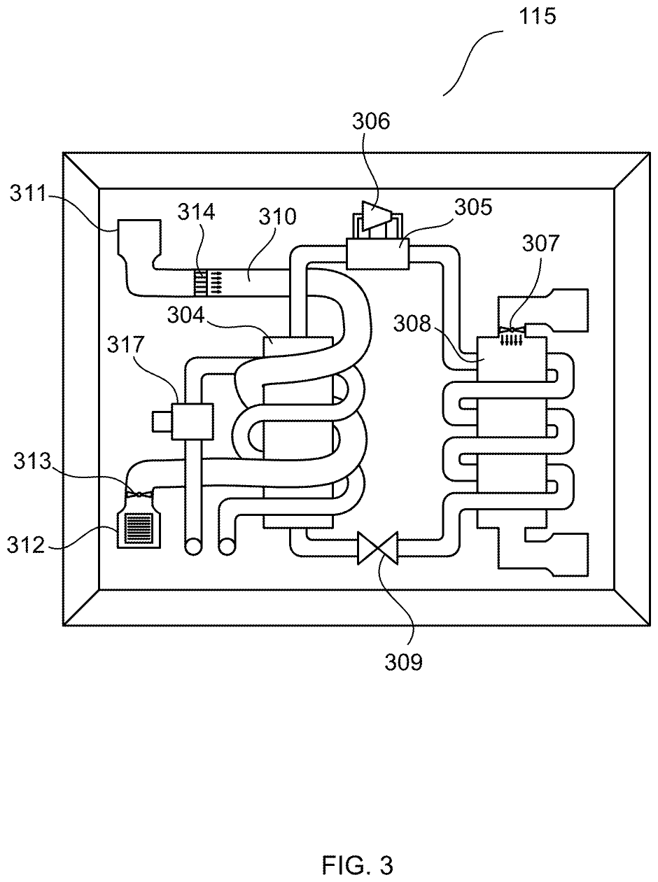

Now referring to FIG. 3, which is an embodiment of the heat exchange device used with the invention. A heat pump 115 is within the wall of a room with a radiant panel (not shown). The fluid in a radiant panel enters the enclosure 318 through an inlet 315, exchanges energy with the heat pump 115 through a heat exchanger 304, which may contain a refrigerant, and exits the enclosure through an outlet 316. The heat exchanger 304 may be a condenser or an evaporator depending on whether the system is heating or cooling the room. The fluid from the radiant panel is moved by a pump 317. The heat pump also contains a reversing valve 305, a compressor 306, and an expansion valve 309. A fan 307 blows air through another heat exchanger 308, which also may be a condenser or an evaporator depending on the mode of the system. This embodiment also includes an additional air tube for bringing fresh air into the house 310, with inlet 311 and outlet 312. The air tube is in thermal communication with heat exchanger 304, so air may be heated or cooled prior to entering the room through outlet 312. A fan 313 moves the air and a filter 314 cleans the air prior to entering the room.

Now referring to FIG. 4. Another embodiment of the invention includes a radiant panel 103 and an in-wall heat exchange device within an enclosure 406. The enclosure 406 includes mounting hardware 409 for hanging the radiant panel 103. The radiant panel 103 includes mounting slots 412 which receive the mounting hardware 409, although the panel may be hung or rested against the wall in other fashions. Fluid lines 415 connect the radiant panel 103 and a heat pump inside the enclosure 418. A decorative cover 424 hides any holes which must be cut in the building (not shown). Air vents 421 allow a stream of air with which to exchange energy enter the enclosure of the heat exchange device 406. The decorative cover 424 in the depicted embodiment also connects to the air vents 421 and diverts the two air streams away from each other. A layer of insulation 427 lines the back side of the enclosure 406.

Now referring to FIG. 5, which shows multiple embodiments of a radiant panel. FIG. 5A shows a radiant panel with a single row of channels 501. Endcaps 502 and 503 keep fluid from escaping the panel. FIG. 5B shows a radiant panel with two rows of channels 504. Endcaps 505 and 506 keep fluid from escaping the panel. FIG. 5C shows a radiant panel with three rows of channels 507. Endcaps 508 and 509 keep fluid from escaping the panel.

Now referring to FIG. 6, which shows an embodiment of the invention with a vacuum layer. A radiant panel 601 has two rows of channels, each comprising a different layer of the panel: a fluid layer 602 and a vacuum layer 603. Some of the partitions of the fluid layer have a notch 604 allowing fluid to flow between them, while others extend to the end of the channel 605 to form a barrier between the partition and the endcaps 606 and 607. This allows a fluid to flow in the same direction through multiple channels, or zones 608. In this embodiment, the vacuum layer does not have any zones. A fluid inlet 609 and outlet (not shown) is on endcap 606. A vacuum nozzle 611 with check valve 612 is mounted on endcap 606 on the side of the vacuum layer, which allows air to be removed from the vacuum layer without reentering.

Now referring to FIG. 7, which shows one embodiment of the invention using plugs to create zones. A radiant panel 103 is shown in a serpentine configuration. Smaller plugs 702 prevent fluid from entering a channel 703, while larger plugs 704 prevent fluid from entering a channel and also passing through the endcaps 705. Zones 706 are created, in this case, each with three channels. The small and large plugs are offset such that fluid flows from side to side in a serpentine configuration through the panel. In this configuration, the endcaps 705 create manifold areas 706 that redirect the fluid back into the channels in contrast to FIG. 6, which uses notches within the channels to do this.

Now referring to FIG. 8. Another embodiment of the invention includes a radiant panel 103 and a square transmission tube 806, which allows the system to be installed through a wall (not shown). The transmission tube 806 includes mounting hardware 809 for hanging the radiant panel. The radiant panel 103 includes mounting slots 812 which receive the mounting hardware 809, although the panel may be hung or rested against the wall in other fashions. Fluid lines 815 connect the radiant panel 103 and a heat pump 818, which in this case contains a decorative cover 824. An air vent 821 allows a flow of air in which to exchange energy with to enter the heat pump 818. Insulation 827 within the transmission tube 806 prevents unwanted air from entering the room. An air duct 833 allows heated or cooled air from the heat pump to enter the room.

Now referring to FIG. 9, which shows a flow diagram of an embodiment of the invention wherein fresh air is heated or cooled in three stages before entering the room. An inflow 905 of air enters a vent 907 and flows through an energy recovery device 910 where it exchanges energy with an outflow 913 of air. The inflow 905 then exchanges energy with the refrigerant (not shown) of a heat pump 915 in a tubular heat exchanger 918, wherein the refrigerant is in an outer tube 920 and the fluid for a radiant panel 103 is in the inner tube 923. In one embodiment of the invention, the air is dehumidified with a dehumidifier 943. It may be a tray that catches condensation 942 which forms as a function of cold air flowing over a cold surface. In another embodiment of the invention, a dehumidifier is included in-line with the air ducts. Fins 924 are used, in an embodiment, to aid heat transfer between the outer tube 920 and the inflow 905. In the depicted embodiment, a tubular heat exchange device is shown, although other heat exchange devices may be used wherein the refrigerant may be in thermal communication with both the fluid and the air. The inflow 905 then flows over at least a portion of the radiant panel, where it is heated or cooled a third time before flowing into the room.

FIG. 9 also shows an outflow 913 which exchanges energy in two stages before exiting the system. It leaves the room through a vent 926 and flows through the energy recovery device 910. It then exchanges energy with the refrigerant in a heat exchanger 928 within the heat pump 915. It then flows out another vent 931, typically to the exterior of the house.

The heat pump in FIG. 9 also includes a compressor 933, and an expansion valve 935. A fan 937 is used to create the inflow 905, and a fan 939 is used to create the outflow 913.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for heating or cooling a room comprising:
a radiant panel comprising a fluid conduit and a front surface, configured to radiate energy to or from a room, and a back surface;
a heat exchange device configured to exchange energy between a fluid and an exchange medium;
a vent for introducing fresh air to a room;
a fan for moving air through the vent; and
a chamber for heating or cooling the air, wherein the chamber at least partially comprises the back surface of the radiant panel.

2. The system of claim 1 wherein the fluid conduit comprises the channels of an extruded sheet of material, wherein the channels are elongated cavities spanning the length of the extruded material.

3. The system of claim 2 wherein the extruded sheet is polycarbonate.

4. The system of claim 1 further comprising at least two heat exchanging regions wherein the fresh air is heated or cooled, wherein the first region is a heat exchanger within the heat exchange device, and the second region is the chamber.

5. The invention of claim 1 wherein the chamber is defined on two sides by the back surface of the panel and a layer of insulation, and wherein the chamber is defined on two other sides by two side walls, and wherein the chamber has at least one opening on a top side or a bottom side.

6. The invention of claim 6 wherein the side walls are supports for the panel, wherein the side walls are mounted to the wall, and the panel is mounted to the side walls.

7. The invention of claim 1 wherein the heat exchange device is configured to be mounted between two studs.

8. The invention of claim 1 wherein the heat exchange device is configured to be mounted to the exterior side of an exterior wall, and wherein the panel is mounted to the interior side of the exterior wall, opposite of the heat exchange device.

9. The invention of claim 9 further comprising a transmission tube, wherein the fresh air and two fluid lines run through the transmission tube.

10. The system of claim 1 further comprising an energy recovery device, wherein the system exchanges energy between an exiting air flow, which is from the room, and the fresh air, within the energy recovery device.

11. The invention of claim 10 further comprising at least three heat exchange regions for the fresh air, wherein the first region is in the energy recovery device, the second region is in a heat exchanger within the heat exchange device, and the third stage is in the chamber.

12. The system of claim 10 further comprising at least two heat exchange regions for the exiting air, wherein the first is the energy recovery device and the second is an evaporator within the heat exchange device.

13. The system of claim 1 further comprising an air filter for filtering the fresh air.

14. The system of claim 1 further comprising a condensation catcher disposed on the bottom of the radiant panel.

15. A method of heating or cooling air comprising;
heating and cooling a refrigerant within a heat pump;
pumping a fluid from the heat pump, through a radiant panel, and back to the heat pump;
receiving outdoor air through a vent;
warming or cooling the outdoor air a first time by exchanging energy between the refrigerant and the outdoor air while simultaneously exchanging energy between the refrigerant and the fluid; and
warming or cooling the outdoor air a second time by passing the outdoor air over the radiant panel.

16. The method of claim 15 wherein the radiant panel comprises a sheet of extruded channels.

17. The method of claim 15 wherein the air is warmed or cooled the second time by passing the air through a heat exchange region comprising the radiant panel, a wall parallel to the radiant panel, and two side walls.

18. A system for heating or cooling a room comprising:
a radiant panel comprised of fluid conduit and a front surface configured to radiate energy to or from a room;
a fluid for heating or cooling the front surface by flowing through the fluid conduit;
a first air-channel;
a second air-channel;
a heat exchange device comprising:
a first heat exchanger in thermal communication with the first air-channel;
a second heat exchanger in thermal communication with the second air-channel; and
a refrigerant flowing through the first heat exchanger and the second heat exchanger;
wherein the first heat exchanger is an air-and-fluid heat exchanging region comprising:
an air-chamber in communication with the first air-channel;
an outer tube containing the refrigerant disposed within the air-chamber; and
an inner tube containing the fluid disposed within the outer tube;
wherein the second heat exchanger is an air to refrigerant heat exchanger configured to exchange energy between the refrigerant and the second air-channel;
a first fan for moving air through the first air-channel;
a second fan for moving air through the second air-channel;
a vent for introducing fresh air to a room in fluid communication with the first air-channel;
wherein when the heat pump is in operation, energy is exchanged between the refrigerant and the fluid and between the refrigerant and the fresh air at the same time; and
wherein when the system is in operation, the room is heated or cooled.

19. The system of claim 18 wherein the fluid conduit comprises the channels of an extruded sheet of material, wherein the channels are elongated cavities spanning the length of the extruded material.

20. The system of claim 18 further comprising a heat exchange chamber in fluid communication with the first air-channel that comprises the radiant panel.
